(19) United States
(12) Patent Application Publication
(10) Pub. No.: US 2026/0019831 A1
(43) Pub. Date: Jan. 15, 2026

(54) ADAPTIVE OBSERVABILITY FOR MOBILE NETWORKS

(71) Applicant: DISH Wireless L.L.C., Englewood, CO (US)

(72) Inventors: Mostafa Tofighbakhsh, Cupertino, CA (US); Arash Mahmoudian, Littleton, CO (US); Mahdi Khansari, Littleton, CO (US)

(21) Appl. No.: 18/771,832

(22) Filed: Jul. 12, 2024

(51) Int. Cl. H04W 24/02; H04L 41/16; H04W 88/08

(52) U.S. Cl. CPC H04W 24/02; H04L 41/16; H04W 88/085

(57) ABSTRACT

Technologies for providing insight data from an edge of a cellular network are described. One method includes first probe data in association with one or more components of the network. The method further includes providing the first probe data to a first model configured to determine first summary data based on the first probe data. The method further includes determining that the first summary data has been requested by a first northbound application. The method further includes providing the first summary data to a central server responsive to determining that the first summary data has been requested by the first northbound application.

### BACKGROUND

Telecommunication networks, such as cellular networks, have various resources that produce data and metadata concerning operations of the cellular network. A customer, such an enterprise customer, of a cellular network does not have access to the data and metadata generated by the network resources of the cellular network. A cellular network may have a variety of probes associated with various network components for providing data indicative of performance of the network. The probes may produce a great deal of data from a network, in some cases many terabytes of data a day of analytic and diagnostic data and metadata may be generated by various components of the network.

One type of cellular network is a Fifth generation (5G) wireless network. In a 5G wireless network, a 5G Standalone Core Network (5G SA core) is responsible for managing and routing data traffic, providing various network resources and services, and supporting the core functionalities of a 5G network. The term “SA” stands for “Stand-Alone,” indicating that this core network operates independently of any existing 4G (LTE) infrastructure. 5G wireless networks have the promise to provide higher throughput, lower latency, and higher availability compared with previous global wireless standards. A combination of control and user plane separation (CUPS) and multi-access edge computing (MEC), which allows compute and storage resources to be moved from a centralized cloud location to the “edge” of a network and closer to end user devices and equipment, may enable low-latency applications with millisecond response times. A control plane may include a part of a network that controls how data packets are forwarded or routed. The control plane may be responsible for populating routing tables or forwarding tables to enable data plane functions. A data plane (or forwarding plane) may include a part of a network that forwards and routes data packets based on control plane logic. Control plane logic may also identify packets to be discarded and packets to which a high quality of service should apply. 5G wireless user equipment (UE) may communicate over both a lower frequency Sub-6 GHz band between 410 MHz and 7125 MHz and a higher frequency mmWave band between 24.25 GHz and 52.6 GHz. As described above, various resources and services of the 5G wireless network are not accessible to a customer for optimizing usage and configuration of these resources in a meaningful and insightful way.

### BRIEF DESCRIPTION OF THE SEVERAL VIEWS OF THE DRAWINGS

The present disclosure is illustrated by way of example, and not by way of limitation, in the figures of the accompanying drawings.

FIG. 1 is a block diagram of an adaptive observability platform including a software defined data pipeline control module, according to some embodiments.

FIG. 2 is a flow diagram of a method for generating and utilizing summary data via an adaptive observability platform, according to some embodiments.

FIG. 3 is a flow diagram of a method for providing summary data for further functions and analysis, according to some embodiments.

FIG. 4A is a flow diagram of a method for managing, utilizing, and updating an adaptive observability architecture, according to some embodiments.

FIG. 4B is a flow diagram of a method for managing an adaptive observability architecture, according to some embodiments.

FIG. 5 illustrates a model training workflow and model application workflow for cellular network data, according to some embodiments.

FIG. 6 depicts a 5G network including a radio access network (RAN) and a core network configured to generate summary data indicative of network performance, according to at least one embodiment.

FIG. 7 depicts a radio access network and a core network for providing a communications channel (or channels) between user equipment and data network according to various embodiments.

### DETAILED DESCRIPTION

Technologies for providing adaptive observability to users of a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

There are new and emerging applications with time sensitive features that could provide significant actionable data to users of a wireless network. However, as described above, a customer or user of a cellular network may not have an ability to reliably and quickly obtain, analyze, utilize, or perform adaptations based on diagnostic data received from the network. The user may receive the data and metadata generated by the resources of the cellular network, but without the ability to customize what measurements are made or what data is received. Further, a network may include many probe functions (e.g., on the order of thousands) which may produce a volume of data that is inconvenient, computationally prohibitive, or impossible to search for insights into improving parameters of the cellular network. For example, some cellular networks may generate terabytes of probe data per day. Conventionally, there are no mechanisms to enable a customer to obtain data in a meaningful and insightful way to manage usage or configuration of network resources in the cellular network.

Aspects and embodiments of the present disclosure address the above and other deficiencies by providing an adaptive observable data generation platform that may provide customized insight data to a customer or user of a cellular network. In some embodiments, a cellular network may include a number of probes for measuring various conditions of the network. The probes may be designed, selected, generated, installed, etc., by one or more designers, engineers, or other personal associated with physical and/or digital architecture of the cellular network, e.g., customers or consumers of the cellular network may not be involved in implementation of probes for measuring conditions of the network.

Probes may exist for measuring any number of properties of a cellular network, including data flow properties, connectivity properties, radio characteristics, or the like. Probes may be included in various components of a cellular network, such as radios (e.g., RANs), distributed units (DUs), central units (CUs), data transport layers, control planes, or the like. In some networks, the number of probes may be quite large, e.g., hundreds, thousands, or more probes may exist in association with a cellular or wireless network. One or more properties of interest to a cellular network user may not be immediately available by probe data. Further, properties of interest may be obscured by a volume of probe data generated by a cellular network. However, it may be possible to determine properties of interest of the network by combining measurements of two or more probes. One or more key indicators of network performance may be available based on output of multiple probes. In some embodiments, a function performed on probe data (e.g., a polynomial function) may provide a target indicator of network performance. In some embodiments, providing probe data to one or more algorithms or models may provide a target indicator of network performance. In some embodiments, providing probe data to one or more statistical models may provide a target indicator of network performance. In some embodiments, providing probe data to one or more trained machine learning models may provide a target indicator of network performance.

In conventional systems, processing of probe data may be performed at a location separated from data generation architecture. For example, a central processing system (e.g., a cloud-based processing system, remote virtual machine, or the like) may be utilized for receiving probe or log data, and generating actionable data for improvement of the cellular network. Such systems suffer from high costs of data transport, including architecture, bandwidth constraints, data and equipment management concerns, etc. Such systems further may suffer from data quality, e.g., data logs may be collected or aggregated by one or more pieces of equipment, equipment of one or more vendors, equipment located at one or more locations, etc., and separation, identification, tagging, etc., of this data may be complex. Further, such operations may be prone to the introduction of various errors or data decorations that inhibit the analysis of the data, in particular subject matter expert independent, or subject matter expert supervised, analysis. For example, analysis that proceeds independent of human intervention, or largely independent of human intervention, may be difficult or impossible based on probe or log data generated, collected, and aggregated in such a way.

In some embodiments, a software defined data pipeline control module may be provided that performs a series of operations to obtain probe or log data, and provide actionable data (e.g., summary data, insight data, corrective action data, etc.) to a central control device (e.g., a control plane of the network). The software defined pipeline control module may oversee, enact, update, etc., process operations of various data reporting components for providing adaptive observability for cellular networks. The software defined data pipeline control module may provide instructions and/or enable operations related to analysis, routing, and transport of data based on historical data logs, probe data, metadata, etc., in association with a cellular network.

In some embodiments, edge computing devices (e.g., devices physically close to regions where probe or log data is generated or collected) may be utilized to perform some analysis on data. The edge computing devices may be installed proximate equipment from which probe data may be obtained. In some embodiments, and edge computing device may obtain data from a radio unit (RU), a DU, a CU, or the like, for example based on availability of access to the various components, proximity to a data collection facility, or the like. In some embodiments, a computing device that receives probe data close to the data generation or aggregation point may be utilized to summarize the data, generate insight data (e.g., analysis, root cause prediction, etc.), generate key performance indicators, recommend corrective actions, or the like. The burden of transport and analysis of the summary data may be far reduced from the burden of transport and analysis of the probe data. In some embodiments, a strategy employing summarization of data proximate data generation or aggregation centers may enable more agile updating of cellular network operation parameters, e.g., to improve operation of the network, to adjust operation of the network responsive to changes in capacity or load, to circumvent one or more damaged components of network architecture, or the like.

Summary data (e.g., edge-generated data, insight data, etc.) may be generated based on the probe data received. Summary data may be data output from one more models, algorithms, functions, or the like which are provided with probe data (and, in some embodiments, tag data) as input. Summary data may include one or more performance indicators. Summary data may include one or more predicted deficiencies of cellular network performance. Summary data may include one or more predicted root causes of deficiencies of cellular network performance. Summary data may include one or more recommended actions to be performed based on performance of the cellular network.

In some embodiments, summary data may be generated based on probe data and historical data. For example, similarities between historical data indicative of a particular cellular network deficiency and current probe data may be utilized in predicting presence of the cellular network deficiency, differences between historical data indicative of a particular cellular network deficiency and current probe data may be utilized in predicting that the network deficiency is not present, etc. Historical data may be utilized in combination with rule-based models, statistical models, machine learning models (in training and/or inference operations of the machine learning models), etc. In some embodiments, performance indicator values may be determined in association with current probe data and historical probe data. In some embodiments, a performance indicator value may be based on historical and current data, e.g., a difference between a historical and current performance indicator value or another relationship between the historical probe data and current probe data.

In some embodiments, summary data may be generated by a trained machine learning model based on a fabric of probe data. For example, a set of probes may provide a data fabric (e.g., a matrix or another form of storing and/or organizing data). The data fabric may include a large amount of data. The data fabric may include data from all probes of a cellular network, all probes selected in association with a target network performance failure, all probes associated with a target network facility or architecture, a subset of these probes, or the like. The data fabric may include a large amount of data. A machine learning model may be trained to generate predictive data responsive to receiving a data fabric as input. Training the machine learning model may include providing data fabrics labeled with one or more network failures, malfunctions, or instances of performance that do not satisfy one or more target threshold performance conditions.

In some embodiments, a machine learning model trained or configured to generate predictive data (e.g., predicted network performance conditions, predicted network performance root causes, predicted corrective actions to improve network performance, or the like) based on data fabric input may enable actions to be taken based on large, non-linear, correlated data sets. Information may be extracted from data fabrics that are not available from a single probe, e.g., the machine learning model may generate and/or form predictions based on summary data of the cellular network. In some embodiments, data of the data fabric may include data from a target duration of time. Data of the data fabric may include data tagged by probes of the cellular network. The trained machine learning model may utilize data of the fabric, relationships between data, information included in data tags, etc., for generating predictive data.

In some embodiments, a software defined data pipeline control module may manage one or more data channels related to processing of probe data. A data channel may be generated responsive to a request, e.g., one or more applications of an upper layer (e.g., executed via processing devices associated with a software defined network of a 5G cellular network, a northbound application, etc.) may interface with the software defined data pipeline control module to generate the data channels, e.g., for providing one or more target performance indicators of the cellular network. The data channel may include one or more analysis procedures for summarizing data from one or more probes. The data channel may include algorithmic, machine learning, statistical, rule-based, or other analysis methods. Updates to the data channel may be made by the software defined data pipeline control module, e.g., responsive to feedback from technicians or subject matter experts, responsive to analysis of further probe data (e.g., did an action taken with respect to summary data improve network functions), or the like.

The software defined data pipeline may manage operations for improving access and/or accessibility of data generated in association with one or more channels. For example, the software defined data pipeline control module may provide instructions to one or more data channels to provide data tagging, data decoration, data cleaning, metadata generation, etc., for more effective use, transport, routing, etc., of the summary data generated in association with each data channel. Data tags may include indications of conditions of data collection, conditions of the cellular network, conditions affecting operations of the cellular network, or the like. Data tags may include indications of a time of measurement, of a type of data packet included or measures, of a size of data packet measured, an identifier of an associated northbound application (e.g., an application that requested a probe measurement), one or more conditions affecting network hardware such as weather conditions, maintenance, conditions, or the like, etc.

The software defined data pipeline control module may initiate and/or manage sampling operations of the data associated with the various data channels. For example, the software defined data pipeline control module may package multiple data channel data streams together to deliver to a northbound application. The software defined data pipeline control module may, upon a data request from a northbound application, select a previously configured data channel as well as another data channel which, in combination, may fulfill the data request. The software defined data pipeline control module may manage operations for sampling and/or packaging data from various data channels for delivery.

The software defined data pipeline control module may initiate, manage, update, etc., operations for routing of data. Routing of data may include providing specifically requested data (e.g., including pre-existing data channels, data from multiple data channel streams, data from channels that the software defined data pipeline control module generates responsive to a request, etc.) to one or more target locations, e.g., data storage facilities, databases, northbound applications, analytics computing devices, etc. The routing may include providing data topically, e.g., a northbound application may provide a request for summary data associated with or belonging to a target topic, such as a particular network action, network component, network facility, network malfunction, or the like, and the software defined data pipeline control module may facilitate delivery of all related data to the application (e.g., based on data tagging or decoration, or another method of determining whether data is relevant to a requested topic).

In some embodiments, a northbound application may receive summary data, e.g., via one or more application programming interfaces (APIs) of the cellular network. In some embodiments, a northbound application may be executed by one or more processing devices of the cellular network, e.g., via software defined network processing. In some embodiments, a northbound application may be executed by one or more processing devices that are not of the cellular network, e.g., a user or technician may execute the northbound application on a client device, a tablet, a laptop, a smart phone, or the like. In some embodiments, a northbound application may provide instructions to one or more components of the network. Instructions may include instructions to provide data to the northbound application. Instructions may include instructions related to data collection, such as a target time of data collection, frequency of data collection, duration of data collection, or the like. Instructions may relate to data generation, such as instructions to include one or more data tags in probe data. Instructions may be actions for improving operation of the cellular network, adjusting resource allocation of the network, adjusting data flow through the cellular network, or the like.

In some embodiments, a northbound application may provide a request for summary data. The request, in some embodiments, may be facilitated by a machine learning model, such as a natural language processing model or a large language model, which may be general purpose or trained specifically for operations associated with the cellular network. For example, a technician, executive, or other person interested in operations of the cellular network may provide a request in natural language for summary data, which may be translated (e.g., by the software defined data pipeline control module) into one or more operations related to obtaining and summarizing probe data, generation of a new data channel, access to one or more data channels, updates to tagging, decoration, sampling, routing, or the like.

Aspects and embodiments of the present disclosure can provide a logical summarized probe data pipeline for third-party applications (e.g., 5G northbound applications) executing in connection with the cellular network. Aspects and embodiments of the present disclosure can enable third-party enterprise applications to leverage O-RAN centric wireless networks to get additional insights for verticals such as health care, Vehicle-to-Everything (V2X), Extended Reality (XR), immersive applications, or the like. V2X is a term used in the automotive and transportation industry to describe communication technology that allows vehicles to communicate with various elements of the surrounding environment. This includes communication between vehicles (V2V), between vehicles and infrastructure (V21), between vehicles and pedestrians (V2P), and more. V2X technology is designed to enhance road safety, traffic efficiency, and overall transportation systems by enabling vehicles to share information about their status, location, and intentions with other vehicles and infrastructure. XR is a term that encompasses virtual reality (VR), augmented reality (AR), mixed reality (MR), and other immersive technologies that combine the physical and digital worlds to create immersive and interactive experiences. These technologies are used in various applications, including gaming, training and simulation, healthcare, education, architecture, and more. The edge computing summary and insight data generation systems can collect data and provide insights as a real-time measurement context of the cellular network to the various applications. The various applications can use the real-time measurement context of the cellular network for dynamic control of one or more resources or services of the cellular network. A customer can use the insight data (i.e., the real-time measurement context) provided by the summary data channels. In particular, aspects and embodiments of the present disclosure can provide a real-time measurement context to one or more network slices serving customer or user of the cellular network.

Aspects and embodiments of the present disclosure can provide specialized virtualized artificial intelligence or machine learning (AI/ML) enabled summarized probe data delivery to third-party enterprise applications in different verticals. Summarized probe data can play a role in addressing a variety of vertical applications that need mission critical insights from the cellular networks that serves them. Aspects and embodiments of the present disclosure can help these new and emerging applications with time sensitive features by providing more context (e.g., real-time context) to their downstream customers, without the complications of data analysis, transport, and storage of large volumes of data, as edge computing devices close to data generation or aggregation sites may perform much of the workload of data analysis operations.

It should be noted that 5G and emerging 6G network architectures are based on the concept of virtual network functions. Aspects and embodiments of the present disclosure can cause the virtual network functions use run-time probes to collect data from data source in the cellular network and interact with additional embedded AI/ML inferences The data sources can be raw counters, logs, events, metrics, traces, alarms, configuration data, flow data, state information, error messages, or the like. A probe agent located at these data sources can be used to collect data items that are aggregated, filtered, or further processed before being input into the AI/ML inferences.

Aspects and embodiments of the present disclosure can obtain input data for the AI/ML inference(s) using probe templates, and the AI/ML inference(s) can provide output data, such as key performance indicators (KPIs) or states of network resources of the cellular network. The KPIs and states can be aggregated by higher interfaces, transfer functions, third-party applications, or the like. These application can be serving their own verticals, leveraging the network primitives, probe functions, and summarized probe data. For example, a monetizable application of a 5G wireless network needs to collect measured sensor information from the 5G wireless network to provide insights into the services they provide to their respective customers. In some cases, there can be a first summarized probe data generation pipeline for an XR application, a second summarized probe data generation pipeline for a V2X application, a third summarized probe data generation pipeline for a manufacturing application, a fourth summarized probe data generation pipeline for a healthcare application, and the like. The respective summarized probe data may be utilized to provide insights into the respective services they provide to their respective customers. The summarized probe data platform can provide these applications with real-time or near-real-time measured data. The real-time or near-real-time measurements can be collected using embedded run-time probe agents, network primitives at the network functions, or the like. The summarized probe data platform can utilize the AI/ML inferences virtual switch function to accelerate coordinated measurements among the distributed probe agents and provide a real-time or near-real-time response to northbound applications via their application programming interfaces (APIs) exposed on the northbound of the summarized probe data platform.

The data channels for probe data collection and analysis into summarized data can assist the applications to be aware of what data context could be available to collect, as well as the AI/ML methods available to process the collected data for observation. It is through these data channels that the applications can populate their context aware intents and the summarized probe data platform can respond to them accordingly to their parameters in the data channels, e.g., as managed and/or updated by the software defined data pipeline control module. For example, the software defined data pipeline control module may initiate generation of one or more data channels, populate those channels with instructions for data analysis (possibly including analysis by AI/ML methods), provide instructions for data tagging, sampling, and routing, and provide updates to any of these instructions as conditions change, feedback is received, or the like. In this context, the various data channels can be viewed as fundamental measurement primitive components, allowing third-party applications to mix and match APIs and data channels into actionable data to meet their needs.

An observability application, e.g., an adaptive observability application based on a software defined data pipeline control module, which may need to compute a set of real-time or near-real-time KPIs or an observability function, obtains one or more data channels associated with summarizing probe data for generating appropriate live network data sets or counters from data stores (e.g., data lakes) through the observability platform northbound interface. The observability application can use the API for collecting appropriate data probes, counters, logs, events for controlling and monitoring the real-time desired probes and KPIs for a period of time set by the data channels. The summarized data platform can provide additional synchronization and scheduling of data channel functions that can bring back additional context for the time-sensitive verticals. In at least one embodiment, the data channel operations can be populated based on natural language from a customer, and the software defined data pipeline control module can have natural language processing to process the natural language to define the set of programmable parameters for one or more data channels of an adaptive observability system.

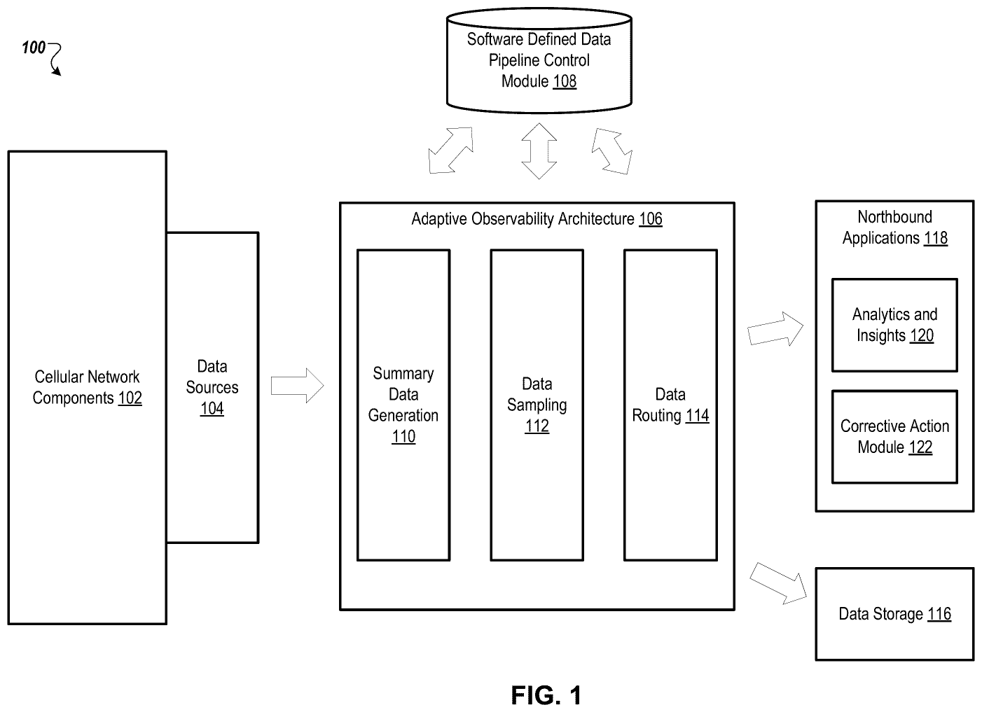

FIG. 1 is a block diagram of an adaptive observability platform 100 including a software defined data pipeline control module 108, according to some embodiments. Platform 100 includes data sources 104, which are associated with cellular network components 102. Data sources 104 may provide probe data to adaptive observability architecture 106. Adaptive observability architecture 106 may include one or more processing devices, memory banks, network connections, input/output devices, etc. Adaptive observability architecture 106 may include one or more general purpose computing device, purpose-built computing devices, customized controllers, or the like. Adaptive observability architecture 106 may include edge computing devices, e.g., computing devices physically located proximate one or more cellular network components 102, data sources 104, or the like. Adaptive observability architecture 106 may be configured to provide data output to one or more northbound locations, functions, or analyses, including data storage 116 (e.g., long-term storage, one or more remote databases, etc.), northbound applications 118 (e.g., applications requesting summary data of software defined data pipeline control module 108), targe locations for analytics and insights 120 (e.g., one or more users, executives, managers, or the like that may request insights, such as via northbound applications 118), and corrective action module 122 (e.g., for updating operations of the network, including operations of cellular network components 102, data sources 104, providing instructions to software defined data pipeline control module 108 to adjust operations of the control module, one or more components of adaptive observability architecture 106, etc.).

Cellular network components 102 may include any equipment of interest included in a cellular network. Data may be generated based on operations of the cellular network components 102, which may be indicative of operations conditions of the network, network traffic, component health or reliability, network failures, service quality, root causes of one or more deficiencies of operation of the cellular network, etc. Cellular network components may include radio units (e.g., of a radio access network), distributed units, central units, components of the transport network or core network, components of a control plane, etc. Further, cellular network components 102 may include network configuration, network topology, historical network configurations, and may generate data based on network test results, measurements, results of adjustments to configuration or topology, or the like.

Data sources 104 may be or include functions for generating data based on the operations of cellular network components 102, or other sources of data indicative of network performance. Data sources 104 may include data probes associated with one or more of the cellular network components 102. Data sources 104 may include data logs associated with operations of cellular network components 102. Data sources 104 may include data aggregations, e.g., data generated by probes associated by a number of RUs may be aggregated at a DU before being provided to adaptive observability architecture 106. Data sources 104 may be collected via various means, e.g., https connections, application programming interface connections, access to data source via command line access, or the like.

The data sources 104 may be physical sensors, digital sensors, software defined data collectors, or the like, for measuring conditions of one or more cellular network components 102. Each of the data sources 104 may be associated with one or more components of cellular network components 102. Probes may be configured to measure one or more conditions of any component of a cellular network, including physical components (e.g., radios, processing devices, data storage devices, or the like), digital components (e.g., data transport layer, control plane, or the like), components that may be executed by hardware or software, components executed by cloud processing systems, or the like. The data sources 104 may perform measurement operations based on instructions received from another component, e.g., software defined data pipeline control module 108. Data sources 104 may perform operations that are programmable, such as a time, duration, frequency, or the like of measurement.

Data sources 104 may include probes, which in at least one embodiment, are software components, code, or other mechanisms used in computing and system monitoring to collect information about the behavior and performance of a network resource, such as one of the components of cellular network components 102, an infrastructure resource, a sensor, a UE, or the like. The probe can be a hardware circuit, a software probe, a virtual probe, or the like. The probe can collect specific data points or metrics from various parts of a system. The probe can collect information from a counter, a log, an event, a stored metric, a trace, an alarm, configuration data, flow data, state information, error messages, or the like. For example, the probe can collect metrics like central processing unit (CPU) usage, memory usage, network traffic, disk input/output (I/O), etc. The probe can continuously sample or measure, at a specified rate, these metrics and make them available for monitoring and analysis. The probe can be used for understanding the current state and health of network resources of the cellular network. A counter, for example, is a type of metric used to keep track of cumulative values over time, such as to count events or occurrences. The counter can be useful for measuring the frequency or rate of events and can provide insights into trends and patterns. A log, for example, can be a textual record generated by the respective resource. The log can capture important information, events, and actions taken by a system. Logs are often used for troubleshooting, auditing, and monitoring. They can contain various types of data, including timestamps, error messages, user actions, and more. An event can be a discrete occurrence or incident that has significance within the resource. Events can represent various types of activities, such as user interactions, system state changes, or errors. Metrics can be quantitative measurements or values that provide insight into the performance, health, or state of a system or application. They can include CPU utilization, memory usage, network bandwidth, response time, and more. Metrics can typically be collected over time to track trends and detect anomalies. Traces can be detailed records of individual transactions or events within a system. They include information about the sequence of actions taken, timestamps, and data associated with each event. Traces can be valuable for diagnosing performance issues and understanding the flow of data or requests through a system. Alarms or alerts can be notifications triggered when specific conditions or thresholds are met. For example, an alarm might be raised when CPU usage exceeds a certain threshold or when a security breach is detected. Alarms are used to notify administrators or automated systems of significant events. Configuration data can include settings, parameters, and configuration files that define how a system or application should behave. It can encompass network configurations, application settings, hardware settings, and more. Changes to configuration data can have a significant impact on system behavior. Flow data, often used in network monitoring, can represent the records of data flows between network devices. It includes information about source and destination IP addresses, port numbers, protocols, and the amount of data transferred. Flow data is useful for analyzing network traffic patterns. State information can represent the current state or condition of a system or application. It includes variables, flags, and data structures that capture the system's status. State information is crucial for maintaining context and continuity in distributed systems. Audit logs can be records of actions and activities performed by users or systems. They are often used for security and compliance purposes, providing a detailed history of who did what and when. Audit logs are crucial for investigating security incidents and maintaining accountability. Performance counters can be specialized metrics that focus on system performance and resource utilization. They can include CPU cycles, memory paging rates, disk I/O operations, and network packet rates. Performance counters are used for fine-grained performance analysis. In network analysis, packet captures (or packet traces) can contain raw network packets, including their headers and payloads. Packet captures are used to inspect network traffic at a granular level, diagnose network issues, and investigate security incidents. Error messages can be notifications generated by systems or applications to indicate that something has gone wrong, or an unexpected condition has been encountered. Error messages often contain diagnostic information to help troubleshoot issues. These data items play essential roles in monitoring, troubleshooting, and optimizing systems, networks, and applications. The choice of which data items to collect and analyze depends on the specific goals and requirements of the monitoring and analysis tasks.

Adaptive observability architecture 106 may include instructions, processors, systems, etc., for performing functions of adaptive observability including summary data generation 110, data sampling 112, data routing 114, etc. Adaptive observability architecture 106 may be in communication with software defined data pipeline control module 108. Adaptive observability architecture 106 may obtain, from software defined data pipeline control module 108, one or more instructions, algorithms, models, functions, or the like to performing data processing on data obtained from data sources 104. Software defined data pipeline control module 108 may utilize subject matter expert knowledge, pre-built models, adaptive model updating, feedback incorporation, and the like to establish, update, adjust, or fine-tune the operations of adaptive observability architecture 106. Operations of software defined data pipeline control module 108 may be executed remotely from adaptive observability architecture 106, e.g., via a central control server, cloud control system, virtual machine, or the like. Adaptive observability architecture 106 may be configured to perform operations (e.g., summary, sampling, and routing operations) without direct intervention or supervision of software defined data pipeline control module 108, e.g., benefits of performing analysis to generate summarized data (e.g., insight data) by an edge computing device may be taken advantage of, without losing advantages of model updates obtained by including a connection to a central control server.

Operations of adaptive observability architecture 106 may include summary data generation 110. Adaptive observability architecture 106 may obtain instructions from software defined data pipeline control module 108 for performing operations to convert data from data sources 104 to one or more summary data streams, e.g., data channels. Channels may be generated to obtain a target performance indicator, to report on operation of one or more pieces of equipment, to provide information regarding network reliability, traffic, configuration, performance, or the like. Data streams or channels may provide summary data (e.g., insight data, analysis output data, etc.) based on algorithmic, functional, rule-based, statistical, heuristic, machine learning, or other types of operations for generating output data. Functions may be put in place on computing devices associated with adaptive observability architecture 106 by software defined data pipeline control module 108, e.g., for execution at an edge computing device proximate one or more data sources 104. Generation of summary data may include tagging or decorating the data, separating of data streams, parsing of incoming data, cleaning of input data and/or output data, etc. Summary data generation 110 may include one or more operations performed by trained machine learning models, such as generating insights, root cause predictions, corrective action predictions, or the like from incoming data from one or more data sources 104. In some embodiments, summary data generation 110 may include reducing an amount of data to be handled by later processes of system 100 by many order of magnitude from the probe/raw data associated with data sources 104. By reducing the volume of data for manipulation, corrective action recommendation, analysis, etc., system 100 may enable more agile and accurate assessments and actions to be performed for improving operation of the cellular network, including network reliability, speed, appropriate network slicing, appropriate allegation of network assets, etc.

Data provided by data sources 104 may be tagged or decorated, etc., with additional information associated with the measurements made by the one or more probes. Probes may tag or decorate data to provide additional information not included in the data. Data tags may include information contextualizing the data provided by the proves. Data tags may include information about the data measurements (e.g., time of measurement, duration of measurement, etc.), information about the data (e.g., size or type of data packet), information indicative of data destination or use (e.g., an identifier of a function the data is to be provided to, an identifier of a northbound application the data is to be provided to, or the like), information identifying a condition of the cellular network (e.g., weather conditions, cellular traffic conditions, radio conditions, etc.), or the like.

In some embodiments, data tags provided to data generated at summary data generation 110 may enable adaptive observability architecture 106 to perform target actions with the summary data. For example, data tags may enable adaptive observability architecture 106 to group summary data of various data channels together for delivery, provide summary data to the correct function or functions, collect the summary data and related historical data, perform one or more operations on the summary data, or the like.

Data sampling 112 may be performed by adaptive observability architecture 106. In some embodiments, a target data destination (e.g., a northbound application 118, a target data storage 116 destination, or the like) may include data requests from multiple data channels of summary data generation 110. For example, software defined data pipeline control module 108 may initiate multiple data streams/channels, which, when combined, may be predicted to fulfil a data request of an upstream application. In some embodiments, a trained machine learning model may obtain a northbound application data request, determine that a combination of summary data channels may fulfil the request, and perform operations to provide those channels to the northbound application, as part of operations of data sampling 112. As a further example, a northbound application 118 may request access to a range of data, e.g., any diagnostic data associated with a particular topic, such as a piece or category of network architecture, a network function, a network slice, or the like. Data sampling 112 may include associating and/or arranging data to be packaged with data of other relevant data channels from summary data generation 110. In some embodiments, data sampling 112 may be performed by, guided by, based on, or the like operations of trained machine learning models, e.g., configured to determine which data streams are of relevance to a request for information from a northbound application of the network.

Data routing 114 may include providing data generated by adaptive observability architecture 106 to various data destinations of interest. In some embodiments, routing may be performed based on data tags/decoration, e.g., applied during summary data generation 110. Data routing 114 may include delivering data for storage (e.g., data storage 116), to one or more northbound applications 118, for analytics and insights 120, to corrective action module 122, etc.

Data storage 116 may include one or more data bases, data stores, data lakes, cloud storage facilities, etc., where data generated by adaptive observability architecture 106 may be stored. Further, data that is not generated by adaptive observability architecture 106 may also be provided to data storage 116. For example, data sources 104 may also provide data to data storage 116, in addition to providing data to adaptive observability architecture 106. In some embodiments, further actions may be taken based on data storage 116. For example, feedback loops may be incorporated based on performance of the network, raw data of data sources 104 in data storage 116, and associated summary data in data storage 116. Corrective action module 122 may generate adjustments to one or more operations of the network, of adaptive observability architecture 106, and/or of software defined data pipeline control module 108 responsive to data of data storage 116. Historical data, of data storage 116, may be utilized by software defined data pipeline control module 108 to adjust operation of adaptive observability architecture 106, to generate one or models or functions for adaptive observability architecture 106 to use to generate summary data, etc.

Northbound applications 118 may include any function to which summary data (e.g., channel data, data stream data, etc.) may be provided. Northbound applications 118 may make requests for network data from software defined data pipeline control module 108, which may generate one or more updates to adaptive observability architecture 106 for providing the information to the northbound applications. Updates to adaptive observability architecture 106 may include generating new data channels, causing one or more data channels to update tagging or decorating, causing data sampling to group a new set of data for the northbound application, updating routing operations to provide the data to the northbound application, etc.

Analytics and insights 120 may be associated with (e.g., may be provided by) northbound applications 118, or may be provided by adaptive observability architecture 106. In some embodiments, analytics and insights 120 may include actionable data for providing to one or more technicians, manager, executives, or the like for providing an understanding of network condition and/or performance, for determining whether to perform corrective actions, for determining additional network capacities that may be unused, or the like.

Corrective action module 122 may include any number of functions for updating operation of some portion of the cellular network. Corrective action module 122 may be considered to be or include one or more northbound applications 118. Corrective action module 122 may receive summary data from adaptive observability architecture 106, and suggest or enact one or more corrective actions based on the summary data. In some embodiments, corrective action module 122 may act substantially autonomously, e.g., summary data may indicate one or more adjustments to operations of various cellular network components 102 to improve network function, and corrective action module 122 may cause these adjustments to be enacted. Adjustments may include adjusting data routing through one or more components, adjusting network slicing, adjusting data bandwidth through one or more components, adjusting radio power, avoiding one or more damaged components, or other network functions which may improve network performance. Corrective action module 122 may also provide updates to software defined data pipeline control module 108, e.g., recommended updates to one or more data channel functions of adaptive observability architecture 106. Corrective action module 122 may be configured to perform corrective actions such as adjusting power output of one or more radios of the cellular network, adjusting antenna tilt or directionality of one or more antennas of the cellular network, adjusting radio resource allocation, adjusting computing device (processing device) resource allocation, adjusting one or more network slices, or the like.

Multiple components of platform 100 may have functions executed by processing devices, data storage devices, or other devices associated with the cellular network, e.g., cellular network components 102. Components of platform 100 may be performed by software applications, software components, hardware components, general computing devices, purpose-built computing devices, virtual machines, cloud-based computing architecture, or the like. In some embodiments, one or more components of platform 100 may be executed as part of a software-defined cellular network, e.g., any or all of the components of platform 100 may be a part of a software-defined network.

In at least one embodiment, a data stream or data channel can be populated based on natural language from a customer, and a northbound application 118 and/or software defined data pipeline control module 108 can have natural language processing to process the natural language to define the set of programmable parameters for generating summary data. The template could have any of the following examples of demands in the requests:
1. Show me all the UEs active on Slice X, Y
2. Show me all the video or voice or data packet data unit (PDU) sessions on specific slice
3. Slice level Probe as a Service provides for customized self-defined probes
4. Provide Real Time Analytics from defined Probes at atomic level
5. Enable Dedicated Enterprise 5G probes mapped to their optimization policies
6. Load balancing among executing logical probes against available slices
7. Utilize probes to Track enterprise customers specific Device Behaviors
8. Enable Dedicated 5G Enterprise Data collection from slice user planes as a services
9. Putting Enterprise customers in charge of their 5G private Data PDU sessions within RAN slices

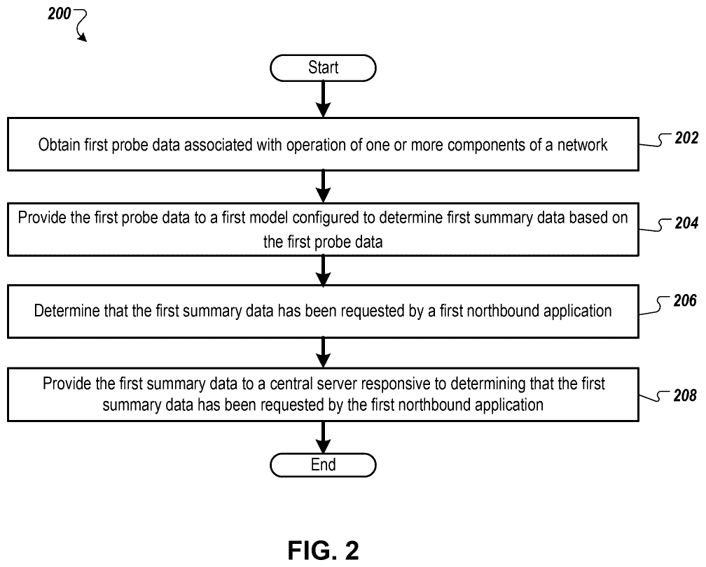

FIGS. 2-3 and 4A-B are flow diagrams of methods 200, 300, and 400A-B associated with adaptive observability platforms including operations of devices managed by a software defined data pipeline control module, according to certain embodiments. Methods 200, 300, and 400A-B may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 200-400 may be performed, in part, by components of platform 100. Methods 200, 300, and 400A-B may be performed by adaptive observability architecture 106, software defined data pipeline control module 108, etc. In some embodiments, a non-transitory machine-readable storage medium stores instructions that when executed by a processing device (e.g., of adaptive observability architecture 106, of platform 100, etc.) cause the processing device to perform one or more of methods 200-300 and 400A-B.

For simplicity of explanation, methods 200-300 and 400A-B are depicted and described as a series of operations. However, operations in accordance with this disclosure can occur in various orders and/or concurrently and with other operations not presented and described herein. Furthermore, not all illustrated operations may be performed to implement methods 200-300 and 400A-B in accordance with the disclosed subject matter. In addition, those skilled in the art will understand and appreciate that methods 200-300 and 400A-B could alternatively be represented as a series of interrelated states via a state diagram or events.

FIG. 2 is a flow diagram of a method 200 for generating and utilizing summary data via an adaptive observability platform, according to some embodiments. Operations of method 200 may be performed by an edge computing device, e.g., a device proximate a DU (associated with a number of RUs), a device proximate a CU (associated with a number of DUs), or the like.

At block 202, process logic obtains first probe data associated with operation of one or more components of a network. The probe data may be logged data, streamed data, or the like. The probe data may include data associate with any network components, including physical components, digital components, processors, or the like. The probe data may be associated with operations of radios, control plane functions, user plane functions, connections to user devices, or the like.

At block 204, process logic provides the first probe data to a first model configured to determine first summary data based on the first probe data. The first model may be stored and/or executed by the edge computing device. The first model may be initiated, installed, trained, updated, or the like by a software defined data pipeline control module, which may be hosted in a central facility, e.g., which is not proximate the cellular network components of interest. The first model may be a trained machine learning model, an artificial intelligence model, a heuristic or rule-based model, a statistical model, a functional or algorithmic model, or the like.

At block 206, process logic determines that the first summary data has been requested by a first northbound application. For example, the first model may be part of a data channel or data stream which is associated with multiple applications for the summary data. The processor (e.g., of an adaptive observability architecture) may determine, based on input provided by the software defined data pipeline control, a destination application of the first summary data. The summary data generation may include operations based on delivery destinations, including tagging or decorating data, data sampling, data routing, etc.

At block 208, process logic provides the first summary data to a central server responsive to determining that the first summary data has been requested by the first northbound application. The central server may host the first northbound application. In some embodiments, the first northbound application may not be hosted by a central server, e.g., the first northbound application may be executed by a mobile device, such as a technician tablet, for providing data for the technician to base corrective actions and other decisions on. In such a case, the summary data may instead or additionally be provided to another device, e.g., the technician's tablet, rather than the central server. In some embodiments, a northbound application or central server may perform further operations based on the summary data, e.g., to generate insights, actionable insights, corrective action recommendations, etc. In some embodiments, further modeling may be done on the summary data, e.g., at the central server or other device associated with data delivery location, machine learning, algorithmic, or other analysis may be performed to determine key performance indicators, root causes, recommended corrective actions, automatic initiation of corrective actions, etc.

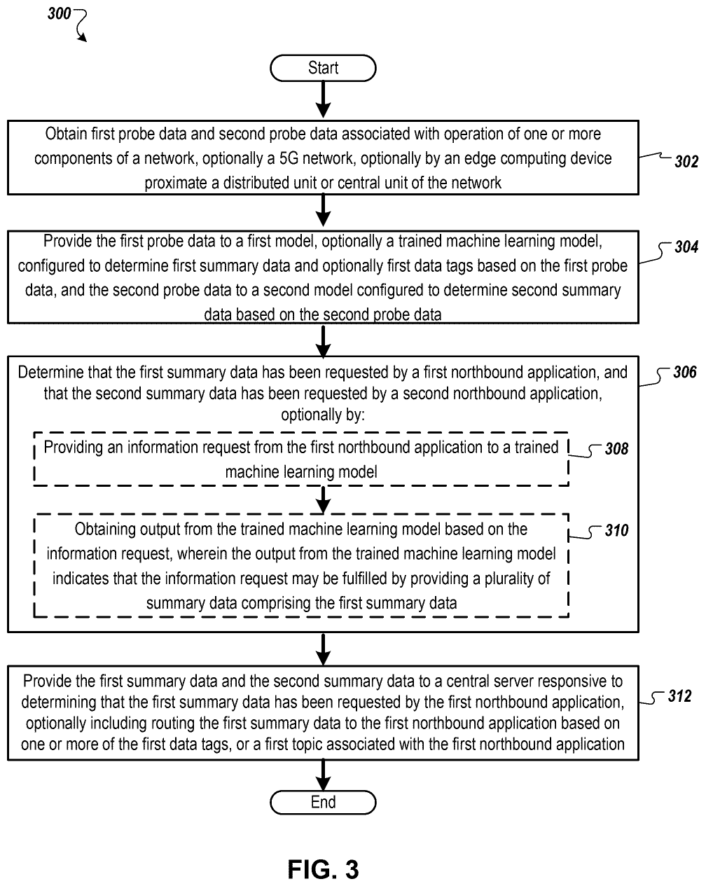

FIG. 3 is a flow diagram of a method 300 for providing summary data for further functions and analysis, according to some embodiments. Operations of method 300 may be performed by an edge computing device, e.g., an adaptive observability architecture. At block 302, process logic obtains first probe data and second probe data associated with operation of one or more components of a network. Each set of probe data (e.g., the first probe data, the second probe data) may be based on one or more components. The sets of probe data may be based on mutually exclusive, overlapping, or common set of components of the cellular network. The cellular network may be a 5G network. The process logic may be executed by an edge computing device proximate one or more components of the network, e.g., the edge computing device may obtain data from a radio access network, from one or more RUs, from one or more DUs (e.g., each associated with a number of RUs), from one or more CUs (e.g., each associated with a number of DUs), or the like. Operations of block 302 may share one or more features with operations of block 202 of FIG. 2.

At block 304, process logic provides the first probe data to a first model and second probe data to a second model. The models may each be trained machine learning models, statistical models, heuristic models, functional models, combinations of models, etc. The first model is configured to generate first summary data based on the first probe data. The second model is configured to generate second summary data based on the second probe data. The models may further be configured to generate additional data in association with the summary data, such as metadata, tagging data, data decoration, etc. Data tagging, metadata, etc., may be utilized by process logic in performing further operations, such as data sampling, routing, etc. Operations of block 304 may share one or more features with operations of block 204 of FIG. 2.

At block 306, process logic determines that the first summary data has been requested by a first northbound application, and that the second summary data has been requested by a second northbound application. In some embodiments, the request from the northbound application may be generated and/or processed by one or more trained machine learning models. For example, a request may be made by a user in natural language for a particular analytic metric, key performance indicator, insight, summary data, or the like, and one or more trained machine learning models may be utilized to translate the natural language request into instructions that may be executed by one or more devices, e.g., a software defined data pipeline control module and an adaptive observability architecture. At block 308, summary data is requested by providing an information request, from the first northbound application, to a trained machine learning model. At block 310, a summary data request is generated by obtaining output from the trained machine learning model based on the information request. Output from the trained machine learning model may indicate that the information request is to be fulfilled by providing a plurality of summary data comprising the first summary data. In some embodiments, a software defined data pipeline control module may determine that an existing data channel or summary data stream may fulfill a data request, or the software defined data pipeline control module may initiate a new data channel to provide data requested by a northbound application. Operations of block 306 may share one or more features with operations of block 206 of FIG. 2.

At block 312, process logic provides the first summary data and the second summary data to a central server, responsive to determining that the first summary data has been requested by the first northbound application. Providing the summary data may include routing the first summary data to the first northbound application based on one or more of data tags associated with the first summary data, or a first topic that the first northbound application has requested data concerning. Operations of block 312 may share one or more features with operations of block 208 of FIG. 2.

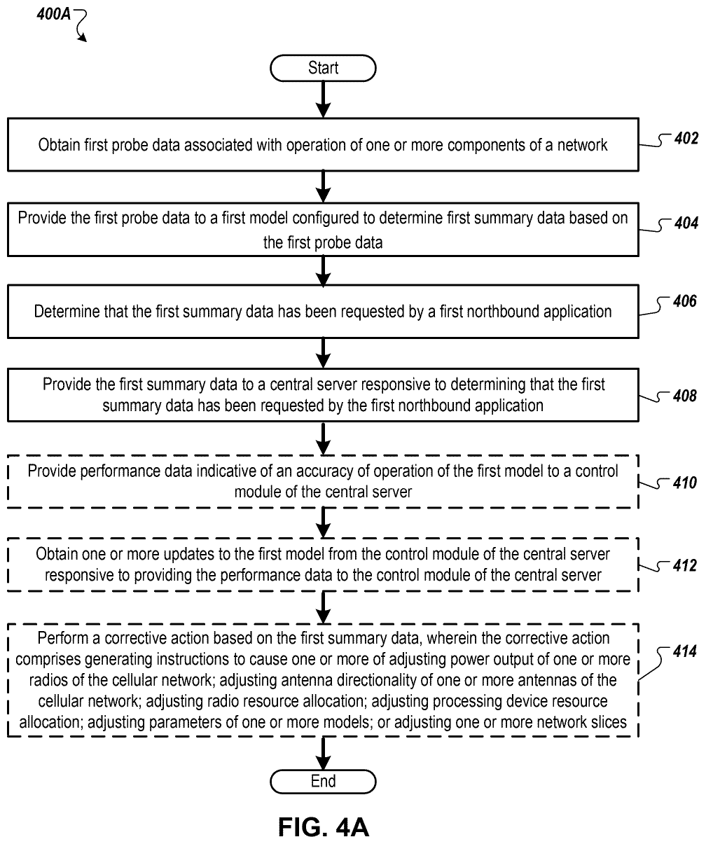

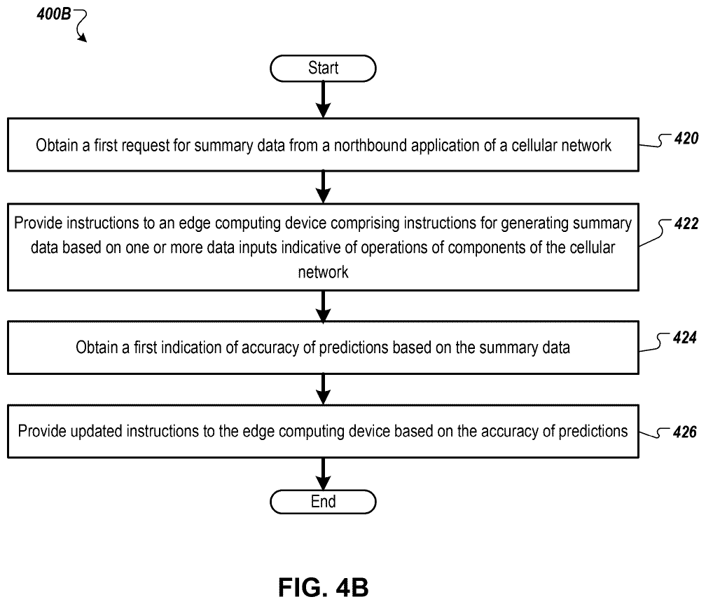

FIG. 4A is a flow diagram of a method 400A for managing, utilizing, and updating an adaptive observability architecture, according to some embodiments. At block 402, process logic obtains first probed data associated with operation of one or more components of a network, such as a cellular or 5G network. At block 404, process logic provides the first probe data to a first model configured to determine first summary data based on the first probe data. At block 406, process logic determines that the first summary data has been requested by a first northbound application. At block 408, process logic provides the first summary data to a central server responsive to determining that the first summary data has been requested by the first northbound application. Blocks 402 through 408 may share one or more features with blocks 302 through 312 of FIG. 3.

At block 410, process logic provides performance data indicative of an accuracy of operation of the first model to a control module of the central server. The performance data, in some embodiments, may instead be provided by a different device, e.g., a software defined data pipeline control module may obtain performance data, feedback data, data indicative of model accuracy, or the like from an adaptive observability architecture, from one or more northbound applications, from input from a subject matter expert, or the like. Performance data may include further summary data, e.g., one or more updates to operation of a cellular network may be performed based on summary data, and whether or not these updates causes desired changes to network function may be further captured in future summary data. Performance data may include summary data related to other components or functions of the network, e.g., an understanding of performance of a first model may be generated based on summary data from a trusted model, summary data associated with a well-documented component or function of the network, or the like.

At block 412, process logic obtains one or more updates to the first model from the control module of the central server responsive to providing the performance data to the control module of the central server. The updates may be intended to improve performance of the model, e.g., the updates may provide adjustments to the model predicted to generated updated output summary data from the model that more accurately reflects operations and conditions of the cellular network.

At block 414, process logic performs a corrective action based on the first summary data. The corrective action may include performing further model updates. The corrective action may include updating one or more control functions, parameters, models, or the like in association with the cellular network. The corrective action may include generating a signal, instruction, or the like that causes another component to enact the corrective action. The corrective action may include adjusting operation of one or more cellular network components. The corrective action may include adjusting power output of one or more radios of the network. The corrective action may include adjusting directionality of one or more antennas of the network. The corrective action may include adjusting radio resource allocation. The corrective action may include adjusting processing device resource allocation, e.g., computing power resource allocation. The corrective action may include adjusting one or more network slices of the network.

FIG. 4B is a flow diagram of a method 400B for managing an adaptive observability architecture, according to some embodiments. Operations of FIG. 4B may be performed by a central control server, a software defined network, a software defined data pipeline control module, a control plane, a core network, or the like. At block 420, process logic obtains a first request for summary data from a northbound application of a cellular network. The request may be based on a natural language request, may be based on a target report, key performance indicator, alert, network malfunction, or the like.

At block 422, process logic provides instructions to an edge computing device. The instructions may include instructions for generating summary data based on one or more data inputs indicative of operation of components of the cellular network. The instructions may include initiating or installing one or more models, e.g., trained machine learning models, rule-based models, statistical models, or the like. The input data may be data generated by one or more data probes indicative of operation of one or more network components.

At block 424, process logic obtains a first indication of accuracy of predictions based on the summary data. The first indication of accuracy may share one or more features with the performance data discussed in connection with block 410 of FIG. 4A. At block 426, process logic provides updated instructions to the edge computing device based on the accuracy of predictions associated with the summary data. For example, feedback based on whether or not one or more corrective actions improves operation of the network, how much operations were improved, how quickly network conditions improved, etc., may be utilized in updating one or more parameters of a model of the edge computing device to increase accuracy of predictions and/or recommendations made by the edge computing device based on future input data.

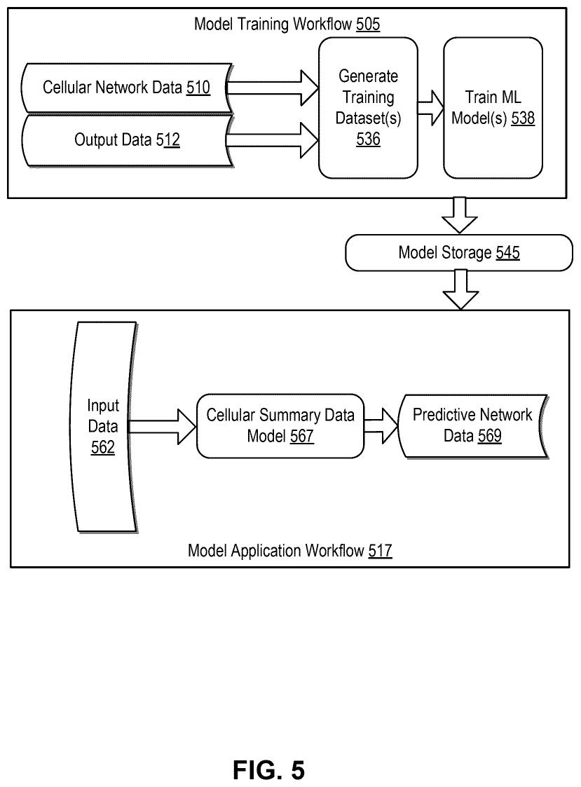

FIG. 5 illustrates a model training workflow 505 and a model application workflow 517 for cellular network data, in accordance with some embodiments of the present disclosure. In embodiments, the model training workflow 505 may be performed at a server or processing device which may or may not be included in architecture of a cellular network (e.g., a computing device of a 5G network executing a software defined data pipeline control module), and the trained models are provided to an edge computing device proximate one or more components of the network, which may perform the model application workflow 517. In some embodiments, one or more of an intelligent data collection platform, probe data correlation platform, feedback control application, reporting application, or the like may execute one or more of model training workflow 505 or model application workflow 517. The model training workflow 505 and the model application workflow 517 may be performed by processing logic executed by a processor of a computing device. One or more of these workflows 505, 517 may be implemented, for example, by one or more machine learning modules implemented by components of platform 100 of FIG. 1.

In one embodiment, the trained machine learning model is a decision tree, a random forest model, a support vector machine, or other type of machine learning model.

In one embodiment, the trained machine learning model is an artificial neural network (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

The trained machine learning model may be periodically or continuously retrained to achieve continuous learning and improvement of the trained machine learning model. The model may generate an output based on an input, an action may be performed based on the output, and a result of the action may be measured. In some instances, the result of the action is measured within seconds or minutes, and, in some instances, it takes longer to measure the result of the action. For example, one or more additional processes may be performed before a result of the action can be measured. The action and the result of the action may indicate whether the output was a correct output and/or a difference between what the output should have been and what the output was. Accordingly, the action and the result of the action may be used to determine a target output that can be used as a label for the measurements. Once the result of the action is determined, the input (e.g., probe data), the output of the trained machine learning model (e.g., recommended corrective actions), and the target result (e.g., correction of a condition of the cellular network not satisfying a target threshold) actual measured result (e.g., measured condition of the network) may be used to generate a new training data item. The new training data item may then be used to further train the trained machine learning model. This retraining process may be performed by components of a software defined cellular network in embodiments.

The model training workflow 505 is to train one or more machine learning models (e.g., deep learning models) to perform one or more classifying, segmenting, detection, recognition, decision, etc., tasks associated with a cellular network. The model application workflow 517 is to apply the one or more trained machine learning models to perform the classifying, segmenting, detection, recognition, determining, etc. tasks for generating data in association with the cellular network, such as summary data, predictive data, instructions for generating summary data (e.g., based on natural language input), tasks for data sampling, tasks for analysis of summary data to generate insights or key performance indicators, etc.

Various machine learning outputs are described herein. Particular numbers and arrangements of machine learning models are described and shown. However, it should be understood that the number and type of machine learning models that are used and the arrangement of such machine learning models can be modified to achieve the same or similar end results. Accordingly, the arrangements of machine learning models that are described and shown are merely examples and should not be construed as limiting.

In embodiments, one or more machine learning models are trained to perform one or more of the below tasks. Each task may be performed by a separate machine learning model. Alternatively, a single machine learning model may perform each of the tasks or a subset of the tasks. Additionally, or alternatively, different machine learning models may be trained to perform different combinations of the tasks. In an example, one or a few machine learning models may be trained, where the trained ML model is a single shared neural network that has multiple shared layers and multiple higher level distinct output layers, where each of the output layers outputs a different prediction, classification, identification, etc. The tasks that the one or more trained machine learning models may be trained to perform are as follows:
a. Generation of summary data based on probe data—As discussed previously, relationships between data based on network components that are available in a cellular network and performance indicators of interest may be complex, non-linear, or the like. A machine learning model may be capable of predicting cellular network performance, generating performance data, generating summary data, recommending corrective actions, or the like by providing values of one or more key performance indicators based on data from a number of probes of the network, without a subject matter expert explicitly defining all relationships between the probe data. The summary data may include classifications (e.g., of service quality, of network performance, etc.), predicted root causes, recommended actions to be taken by the software defined network, recommended maintenance, or actions to be taken by users or technicians, or the like.
b. Data sampling of summary data-In some embodiments, summary data may be generated by one or more data channels or data streams, and delivery to various data destinations may be based on machine learning output. One of more machine learning models may be utilized to associate one or more data channels to each of a number of northbound applications. The machine learning models may be configured to obtain one or more target sets of information in association with a northbound application request, and determine which data channels are relevant to the target information.
c. Generation of data channels based on natural language—In some embodiments, a machine learning model (e.g., executed by a northbound application) may receive as input a natural language request, and may translate the natural language request into a machine-readable request for summary data, e.g., by generating a function to match the request, by selecting a function to match the request, by causing a function to be executed on probe data to be collected at a specific time, frequency, or duration to match the request, or the like.
d. High-level analysis based on summary data—in some embodiments, further modeling may be performed based on summary data provided via various data channels to an upstream or northbound application.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

For the model training workflow 505, a training dataset containing hundreds, thousands, tens of thousands, hundreds of thousands or more cellular network data 510 (e.g., probe data, historical probe data, service-chained data requests, etc.) should be used to form a training dataset. In embodiments, the training dataset may also include associated outcome data 512 (e.g., associated key performance indicator values, associated corrective actions, associated machine-readable service-chained probe data requests, etc.) for forming a training dataset, where each data point and/or associated configuration may include various labels or classifications of one or more types of useful information. This data may be processed to generate one or multiple training datasets 536 for training of one or more machine learning models.

To effectuate training, processing logic inputs the training dataset(s) 536 into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the cellular network data 510 and output data 512 into the machine learning model one at a time. In some embodiments, the training of the machine learning model includes tuning the model to receive cellular network data 510 and output predictive data (e.g., predictions of network performance). The machine learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce.

Accordingly, the output may include one or more predictions or inferences. For example, an output prediction or inference may include summary data, indications of cellular network performance, or the like. Processing logic may cause one or more updates to the cellular network based on the output. Processing logic may provide summary data to one or more northbound applications. Processing logic may provide requests for summary data to components of the network, such as a software defined data pipeline control module.

Processing logic may compare the generated output against a target output (e.g., a label corresponding to the “correct answer”) and determine whether a threshold criterion is met (e.g., threshold similarity between the generated output and target output). Processing logic determines an error (i.e., a classification error) based on the differences between the generated output and the target output. Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria are met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

As an example, in one embodiment, a machine learning model (e.g., cellular summary data model 567) is trained to determine summary data (e.g., an indicator of performance quality of a cellular network). A similar process may be performed to train machine learning models to perform other tasks such as those set forth above. A set of many (e.g., thousands to millions) sets of probe data may be collected and performance indicators may be determined based on the probe data.

Once one or more trained machine learning models 538 are generated, they may be stored in model storage 545, and may be added to a cellular network, e.g., a northbound application, an edge computing device, a software defined data pipeline control module, or the like. The cellular network may then use the one or more trained ML models 538 as well as additional processing logic to implement an automatic mode, in which user manual input of information is minimized or even eliminated in some instances.

For model application workflow 517, according to one embodiment, input data 562 may be input into cellular summary data model 567, which may include a trained neural network. Based on the input data 562, cellular summary data model 567 outputs information indicating summarized data indicative of insights, network performance, or the like. Cellular summary data model 567 generates predictive network data 569, which may include summary data, recommended actions, summary data requests, predicted root causes, or the like.

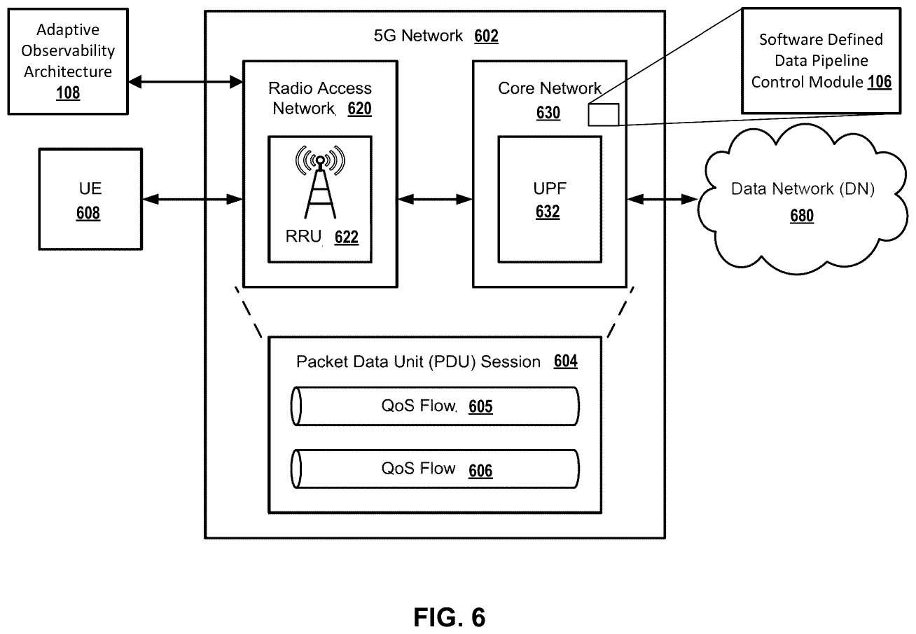

FIG. 6 depicts a 5G network 602 including a radio access network (RAN) 620 and a core network 630 configured to generate summary data indicative of network performance, according to at least one embodiment. In at least one embodiment, the software defined data pipeline control module 106, and/or the adaptive observability architecture 108, of FIG. 1 can be implemented in network 602 to provide summary data as described herein. The software defined data pipeline control module 106 may be executed as part of core network 630. Adaptive observability architecture 108 may be in communication with one or more components of radio access network 620, e.g., may receive probe data from radio access network 620 for generation of summary data, data channels, data streams, insight data, or th like. The RAN 620 can include a new-generation radio access network (NG-RAN) that uses the 5G new radio interface (NR). The 5G network 602 connects user equipment (UE) 608 to the data network (DN) 680 using the RAN 620 and the core network 630. The data network 680 can include the Internet, a local area network (LAN), a wide area network (WAN), a private data network, a wireless network, a wired network, or a combination of networks. The UE 608 can include an electronic device with wireless connectivity or cellular communication capability, such as a mobile phone or handheld computing device. In at least one example, the UE 608 can include a 5G smartphone or a 5G cellular device that connects to the RAN 620 via a wireless connection. The UE 608 can include one of a number of UEs not depicted that are in communication with the RAN 620. The UEs may include mobile and non-mobile computing devices. The UEs may include laptop computers, desktop computers, an Internet-of-Things (IoT) devices, and/or any other electronic computing device that includes a wireless communications interface to access the RAN 620.

The RAN 620 includes a remote radio unit (RRU) 622 for wirelessly communicating with UE 608. The remote radio unit (RRU) 622 can include a Radio Unit (RU) and may include one or more radio transceivers for wirelessly communicating with UE 608. The remote radio unit (RRU) 622 may include circuitry for converting signals sent to and from an antenna of a Base Station into digital signals for transmission over packet networks. The RAN 620 may correspond with a 5G radio Base Station that connects user equipment to the core network 630. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 608.

Adaptive observability architecture 108 may be located proximate one or more components of radio access network 620, and may receive data from the radio access network 620 for generation of summary data, for generation of predictive data, for recommending corrective actions, or the like. Adaptive observability architecture 108 may access data of radio access network 620 wireless, via a network, via a wired connection, via an API, or the like.

The core network 630 may utilize a cloud-native service-based architecture (SBA) in which different core network functions (e.g., authentication, security, session management, and core access and mobility functions) are virtualized and implemented as loosely coupled independent services that communicate with each other, for example, using HTTP protocols and APIs. In at least one embodiment, the software defined data pipeline control module 106 can be implemented in control plane (CP) functions executed by core network 630. In at least one embodiment, an architecture in which software is composed of small independent services that communicate over well-defined APIs may be used for implementing some of the core network functions. For example, control plane (CP) network functions for performing session management may be implemented as containerized applications. A container-based implementation may offer improved scalability and availability over other approaches.

The primary core network functions can include the access and mobility management function (AMF), the session management function (SMF), and the user plane function (UPF). The UPF (e.g., UPF 632) may perform packet processing including routing and forwarding, quality of service (QOS) handling, and packet data unit (PDU) session management. The UPF may serve as an ingress and egress point for user plane traffic and provide anchored mobility support for user equipment. For example, the UPF 632 may provide an anchor point between the UE 608 and the data network 680 as the UE 608 moves between coverage areas. The AMF may act as a single-entry point for an UE connection and perform mobility management, registration management, and connection management between a data network and UE. The SMF may perform session management, user plane selection, and IP address allocation.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 620, such as a Distributed Unit (DU) and a centralized unit (CU), may need to be deployed at a cell site or in a local data center (LDC) that is in close proximity to a cell site such that the latency requirements are satisfied (e.g., such that the one-way latency from the cell site to the DU component or CU component is less than 1.2 ms).

In some embodiments, the Distributed Unit (DU) and the centralized unit (CU) of the RAN 620 may be co-located with the remote radio unit (RRU) 622. In other embodiments, the Distributed Unit (DU) and the remote radio unit (RRU) 622 may be co-located at a cell site and the centralized unit (CU) may be located within a local data center (LDC). In some embodiments, adaptive observability architecture 108 may be disposed proximate a DU, a CU, one or more RRUs 622, or the like.

The 5G network 602 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 602. In some cases, the 5G network 602 may support customized policy configuration and enforcement between network slices per service level agreements (SLAs) within the radio access network (RAN) 620. User equipment, such as UE 608, may connect to multiple network slices at the same time (e.g., eight different network slices). In one embodiment, a PDU session, such as PDU session 604, may belong to only one network slice instance.

In some cases, the 5G network 602 may dynamically generate network slices to provide telecommunications services for various use cases, such the enhanced Mobile Broadband (cMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents. Operations of software defined data pipeline control module 106 may be executed based on cloud computing resources.

The core network 630 may include a set of network elements that are configured to offer various data and telecommunications services to subscribers or end users of user equipment, such as UE 608. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment.

In some embodiments, applications and services may be run using virtual machines instead of containers in order to improve security. A common virtual machine may also be used to run applications and/or containers for a number of closely related network services.

The 5G network 602 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

As depicted in FIG. 6, the core network 630 includes a user plane function (UPF) 632 for transporting IP data traffic (e.g., user plane traffic) between the UE 608 and the data network 680 and for handling packet data unit (PDU) sessions with the data network 680. The UPF 632 can include an anchor point between the UE 608 and the data network 680. The UPF 632 may be implemented as a software process or application running within a virtualized infrastructure or a cloud-based compute and storage infrastructure. The 5G network 602 may connect the UE 608 to the data network 680 using a PDU session 604, which can include part of an overlay network.

The PDU session 604 may utilize one or more quality of service (QOS) flows, such as QoS flows 605 and 606, to exchange traffic (e.g., data and voice traffic) between the UE 608 and the data network 680. The one or more QoS flows can include the finest granularity of QoS differentiation within the PDU session 604. The PDU session 604 may belong to a network slice instance through the 5G network 602. To establish user plane connectivity from the UE 608 to the data network 680, an AMF that supports the network slice instance may be selected and a PDU session via the network slice instance may be established. In some cases, the PDU session 604 may be of type IPv4 or IPv6 for transporting IP packets. The RAN 620 may be configured to establish and release parts of the PDU session 604 that cross the radio interface.

The RAN 620 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 608, over a geographic area. Some cells may correspond with stationary coverage areas and other cells may correspond with coverage areas that change over time (e.g., due to movement of a mobile RRU).

In some cases, the UE 608 may be capable of transmitting signals to and receiving signals from one or more RRUs within the network of cells over time. One or more cells may correspond with a cell site. The cells within the network of cells may be configured to facilitate communication between UE 608 and other UEs and/or between UE 608 and a data network, such as data network 680. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 fect). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

UPF 632 may be responsible for routing and forwarding user plane packets between the RAN 620 and the data network 680. Uplink packets arriving from the RAN 620 may use a general packet radio service (GPRS) tunneling protocol (or GTP) to reach the UPF 632. The GPRS tunneling protocol for the user plane may support multiplexing of traffic from different PDU sessions by tunneling user data over the interface between the RAN 620 and the UPF 632.

The UPF 632 may remove the packet headers belonging to the GTP tunnel before forwarding the user plane packets towards the data network 680. As the UPF 632 may provide connectivity towards other data networks in addition to the data network 680, the UPF 632 must ensure that the user plane packets are forwarded towards the correct data network. Each GTP tunnel may belong to a specific PDU session, such as PDU session 604. Each PDU session may be set up towards a specific data network name (DNN) that uniquely identifies the data network to which the user plane packets should be forwarded. The UPF 632 may keep a record of the mapping between the GTP tunnel, the PDU session, and the DNN for the data network to which the user plane packets are directed.

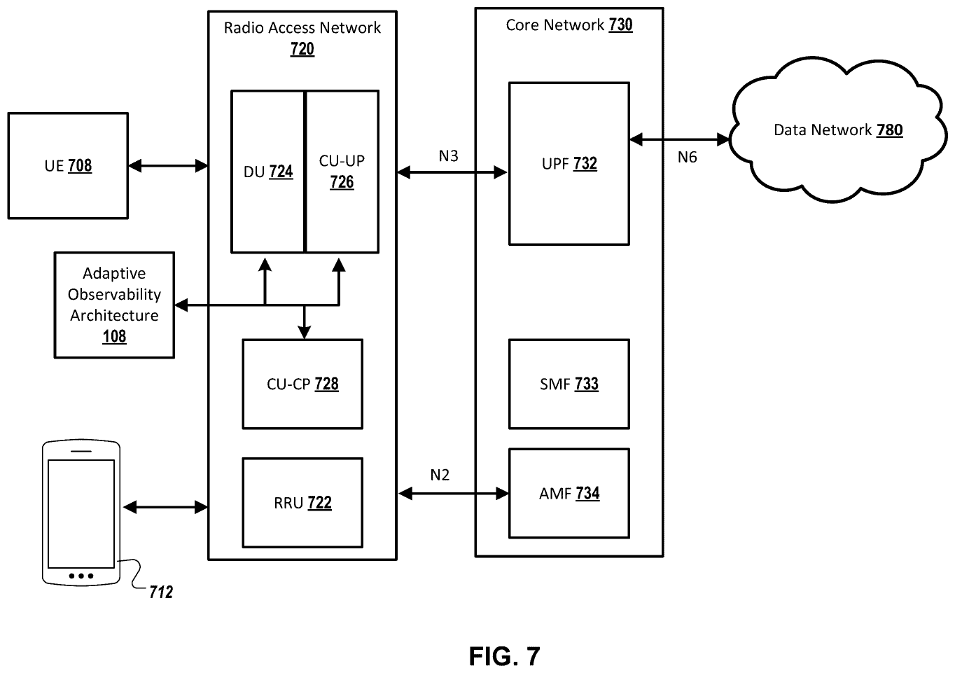

Downlink packets arriving from the data network 680 are mapped onto a specific QoS flow belonging to a specific PDU session before forwarded towards the appropriate RAN 620. A QoS flow may correspond with a stream of data packets that have equal quality of service (QOS). A PDU session may have multiple QoS flows, such as the QoS flows 605 and 606 that belong to PDU session 604. The UPF 632 may use a set of service data flow (SDF) templates to map each downlink packet onto a specific QoS flow. The UPF 632 may receive the set of SDF templates from a session management function (SMF), such as the SMF 733 depicted in FIG. 7, during setup of the PDU session 604. The SMF may generate the set of SDF templates using information provided from a policy control function (PCF), such as the PCF 735 depicted in FIG. 7. The UPF 632 may track various statistics regarding the volume of data transferred by each PDU session, such as PDU session 604, and provide the information to an SMF.

FIG. 7 depicts a RAN 720 and a core network 730 for providing a communications channel (or channel) between user equipment and data network 780 according to at least one embodiment. In at least one embodiment, the adaptive observability architecture 108 can be implemented proximate one or more components of RAN 720 to generate summary data as described herein. The communications channel can include a pathway through which data is communicated between the UE 708 and the data network 780. The user equipment in communication with the RAN 720 includes UE 708, and mobile computing device 712. The user equipment may include a set of electronic devices, including mobile computing device and non-mobile computing device.

The core network 730 includes network functions such as an access and mobility management function (AMF) 734, a session management function (SMF) 733, and a user plane function (UPF) 732. The AMF may interface with user equipment and act as a single-entry point for a UE connection. The AMF may interface with the SMF to track user sessions. The AMF may interface with a network slice selection function (NSSF) not depicted to select network slice instances for user equipment, such as UE 708. When user equipment is leaving a first coverage area and entering a second coverage area, the AMF may be responsible for coordinating the handoff between the coverage areas whether the coverage areas are associated with the same radio access network or different radio access networks.

The UPF 732 may transfer downlink data received from the data network 780 to user equipment, such as UE 708, via the RAN 720 and/or transfer uplink data received from user equipment to the data network 780 via the RAN 720. An uplink can include a radio link though which user equipment transmits data and/or control signals to the RAN 720. A downlink can include a radio link through which the RAN 720 transmits data and/or control signals to the user equipment.

The RAN 720 may be logically divided into a remote radio unit (RRU) 722, a Distributed Unit (DU) 724, and a centralized unit (CU) that is partitioned into a CU user plane portion (CU-UP) 726 and a CU control plane portion (CU-CP) 728. The CU-UP 726 may correspond with the centralized unit for the user plane and the CU-CP 728 may correspond with the centralized unit for the control plane. The CU-CP 728 may perform functions related to a control plane, such as connection setup, mobility, and security. The CU-UP 726 may perform functions related to a user plane, such as user data transmission and reception functions. Adaptive observability architecture 108 may be in communication with any one, or any combination, of DU 724, CU-UP 726, and/or CU-CP 728. In some embodiments, adaptive observability architecture 108 may be in communication with one or more RRUs 722.

Decoupling control signaling in the control plane from user plane traffic in the user plane may allow the UPF 732 to be positioned in close proximity to the edge of a network compared with the AMF 734. In at least one embodiment, the intelligent data collector 106 can be implemented in the AMF 734. As a closer geographic or topographic proximity may reduce the electrical distance, this means that the electrical distance from the UPF 732 to the UE 708 may be less than the electrical distance of the AMF 734 to the UE 708. The RAN 720 may be connected to the AMF 734, which may allocate temporary unique identifiers, determine tracking areas, and select appropriate policy control functions (PCFs) for user equipment, via an N2 interface. The N3 Interface may be used for transferring user data (e.g., user plane traffic) from the RAN 720 to the user plane function UPF 732 and may be used for providing low-latency services using edge computing resources. The electrical distance from the UPF 732 (e.g., located at the edge of a network) to user equipment, such as UE 708, may impact the latency and performance services provided to the user equipment. In a similar manner, adaptive observability architecture 108, executed by an edge computing device located proximate one or more components of the RAN 720, may benefit from reduced latency, reduced cost associated with transmitting large quantities of data across long distances, or the like.

The UE 708 may be connected to the SMF 733 via an N1 interface not depicted, which may transfer UE information directly to the AMF 734. The UPF 732 may be connected to the data network 780 via an N6 interface. The N6 interface may be used for providing connectivity between the UPF 732 and other external or internal data networks (e.g., to the Internet). The RAN 720 may be connected to the SMF 733, which may manage UE context and network handovers between Base Stations, via the N2 interface. The N2 interface may be used for transferring control plane signaling between the RAN 720 and the AMF 734.

The RRU 722 may perform physical layer functions, such as employing orthogonal frequency-division multiplexing (OFDM) for downlink data transmission. In some cases, the DU 724 may be located at a cell site (or a cellular Base Station) and may provide real-time support for lower layers of the protocol stack, such as the radio link control (RLC) layer and the medium access control (MAC) layer. The CU may provide support for higher layers of the protocol stack, such as the service data adaptation protocol (SDAP) layer, the packet data convergence control (PDCP) layer, and the radio resource control (RRC) layer. The SDAP layer can include the highest L2 sublayer in the 5G NR protocol stack. In some embodiments, a radio access network may correspond with a single CU that connects to multiple DUs (e.g., 10 DUs), and each DU may connect to multiple RRUs (e.g., 18 RRUs). In this case, a single CU may manage 10 different cell sites (or cellular Base Stations) and 180 different RRUs.

In some embodiments, the RAN 720 or portions of the RAN 720 may be implemented using multi-access edge computing (MEC) that allows computing and storage resources to be moved closer to user equipment. Allowing data to be processed and stored at the edge of a network that is located close to the user equipment may be necessary to satisfy low-latency application requirements. In at least one example, the DU 724 and CU-UP 726 may be executed as virtual instances within a data center environment that provides single-digit millisecond latencies (e.g., less than 2 ms) from the virtual instances to the UE 708.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
obtaining, by an edge computing device, first probe data associated with operation of one or more components of a cellular network;
providing the first probe data to a first model configured to determine first summary data based on the first probe data;
determining that the first summary data has been requested by a first northbound application; and
providing the first summary data to a central server responsive to determining that the first summary data has been requested by the first northbound application.

2. The method of claim 1, further comprising:
providing, by the edge computing device, second probe data to a second model configured to determine second summary data based on the second probe data;
determining that the second summary data has been requested by a second northbound application; and
providing the second summary data to the central server responsive to determining that the second summary data has been requested by the second northbound application.

3. The method of claim 1, wherein the first model comprises a trained machine learning model configured to classify whether operations of the one or more components are abnormal.

4. The method of claim 1, wherein determining that the first summary data has been requested by a first northbound application comprises:
providing an information request from the first northbound application to a trained machine learning model configured to determine whether the first summary data is related to the information request; and
obtaining output from the trained machine learning model based on the information request, wherein the output from the trained machine learning model indicates that the information request is to be fulfilled by providing a plurality of summary data comprising the first summary data.

5. The method of claim 1, further comprising:
providing performance data indicative of an accuracy of operation of the first model to a control module of the central server; and
obtaining one or more updates to the first model from the control module of the central server responsive to providing the performance data to the control module of the central server.

6. The method of claim 1, wherein the edge computing device obtains the first probe data from a distributed unit of the cellular network, proximate the edge computing device, wherein the distributed unit is associated with a plurality of radio units.

7. The method of claim 1, wherein the edge computing device obtains the first probe data from a central unit of the cellular network, proximate the edge computing device, wherein the central unit is associated with a plurality of distributed units.

8. The method of claim 1, wherein the first model is further configured to generate a plurality of tags in association with the first summary data, and wherein determining that the first summary data has been requested by the first northbound application comprises determining that a tag associated with the first northbound application is associated with the first summary data.

9. The method of claim 1, wherein determining that the first summary data has been requested by the first northbound application comprises determining that the first data belongs to a first topic, and determining that the first topic is associated with the first northbound application.

10. The method of claim 1, further comprising performing a corrective action based on the first summary data, wherein the corrective action comprises one or more of:
adjusting power output of one or more radios of the cellular network;
adjusting antenna directionality of one or more antennas of the cellular network;
adjusting radio resource allocation;
adjusting processing device resource allocation; or
adjusting one or more network slices.

11. One or more non-transitory, computer-readable storage media having computer-readable instructions thereon which, when executed by one or more processing devices, cause the one or more processing devices to perform operations comprising:
obtaining first probe data associated with operation of one or more components of a cellular network;
providing the first probe data to a first model configured to determine first summary data based on the first probe data;
determining that the first summary data has been requested by a first northbound application; and
providing the first summary data to a central server responsive to determining that the first summary data has been requested by the first northbound application.

12. The one or more non-transitory, computer-readable storage media of claim 11, wherein the first model comprises a trained machine learning model configured to classify whether operations of the one or more components are abnormal.

13. The one or more non-transitory, computer-readable storage media of claim 11, wherein determining that the first summary data has been requested by a first northbound application comprises:
providing an information request from the first northbound application to a trained machine learning model; and
obtaining output from the trained machine learning model based on the information request, wherein the output from the trained machine learning model indicates that the information request may be fulfilled by providing a plurality of summary data comprising the first summary data.

14. The one or more non-transitory, computer-readable storage media of claim 11, wherein the operations further comprise:
providing performance data indicative of an accuracy of operation of the first model to a control module of the central server; and
obtaining one or more updates to the first model from the control module of the central server responsive to providing the performance data to the control module of the central server.

15. The one or more non-transitory, computer-readable storage media of claim 11, wherein the one or more processing devices comprise an edge computing device, and wherein the edge computing device obtains the first probe data from a central unit of the cellular network, proximate the edge computing device, wherein the central unit is associated with a plurality of distributed units.

16. A system comprising memory and a processing device coupled to the memory, wherein the processing device is configured to:
obtain first probe data associated with operation of one or more components of a cellular network;
provide the first probe data to a first model configured to determine first summary data based on the first probe data;
determine that the first summary data has been requested by a first northbound application; and
provide the first summary data to a central server responsive to determining that the first summary data has been requested by the first northbound application.

17. The system of claim 16, wherein the first model comprises a trained machine learning model.

18. The system of claim 16, wherein determining that the first summary data has been requested by a first northbound application comprises:
providing an information request from the first northbound application to a trained machine learning model; and
obtaining output from the trained machine learning model based on the information request, wherein the output from the trained machine learning model indicates that the information request may be fulfilled by providing a plurality of summary data comprising the first summary data.

19. The system of claim 16, wherein the processing device is further configured to:
provide performance data indicative of an accuracy of operation of the first model to a control module of the central server; and
obtain one or more updates to the first model from the control module of the central server responsive to providing the performance data to the control module of the central server.

20. The system of claim 16, wherein the processing device comprise an edge computing device, and wherein the edge computing device obtains the first probe data from a central unit of the cellular network, proximate the edge computing device, wherein the central unit is associated with a plurality of distributed units.
